(19) United States
(12) Patent Application Publication
(10) Pub. No.: US 2003/0101598 A1
(43) Pub. Date: Jun. 5, 2003

(54) Knife blade assembly

(76) Inventor: Chen-Fen Chen, Nantou City (TW)

Correspondence Address: Connolly and Hutz, P.O. Box 2207, Wilmington, DE, 19899-2207, US

(21) Appl. No.: 10/005,940

(22) Filed: Dec. 4, 2001

(51) Int. Cl. B25G 3/00

(52) U.S. Cl. 30/342; 30/340

(57) ABSTRACT

A knife blade assembly comprises a blade and a connecting piece. The connecting piece has an insertion part at an upper side. A rear extension of the blade is inserted in the insertion part and firmly connected therewith.

### BACKGROUND OF THE INVENTION

1. Field of the Invention

The present invention relates to a knife blade assembly, particularly to a knife blade assembly having a forged connecting piece, which is produced with reduced working effort and cost and increased speed, without reducing strength thereof.

2. Description of Related Art

Conventional forged knives are manufactured by way of forging machines with forging dies. In practice, several forging machines are needed to perform continuous forging step by step. However, each of the forging machines used is large size so that a large working space has to be occupied in case of these forging machines being arranged for implementing forging. In addition, wear generating from each pair of forging die is significant due to every single knife requiring at least a pair of forging die. Therefore, the manufacturing process is complicated and the production cost is pretty high. Furthermore, the steel material used undergoes a much high wear rate as well during forging. Hence, the following three ways have been suggested for improving the preceding problems.

1. Assembly type: A knife is made of two or three structural parts, which are welded together at a front side or rear side of a connecting piece, so that a blade, the connecting piece and a rear extension become a single body.

2. Hot melting and squeezing type: A non-forged steel sheet at a spot thereof for a connecting end is hot molten and squeezed into a tumor shape, and then the tumor spot is forging-pressed into a shape of connecting piece.

3. Forging imitation type: A hollow piece or two thick material pieces can be welded to both lateral sides of a rear extension of a blade, then the welded hollow piece or the two thick material pieces can be worked to form a connecting piece.

The preceding manufacturing methods are simple and convenient ways to shape knives. There are, however, the following shortcomings:

1. For the assembly type, the blade, the connecting piece and the rear extension are welded together at flat sides thereof, and the outer joining surfaces thereof are non-flat surfaces. Because the outer surface of the handle part has to be treated, an insufficient joining area is left for welding at the outer surface thereof. When cutting is performed parallel to the connection, resulted vertical forces easily cause the contact surface to become brittle and subsequent fracture thereof.

2. For the hot melting and squeezing type, the melted and squeezed steel sheet that has a tumor shape requires a specific and costly working machine tool. Furthermore, subsequent working is complicated, ineffective and imprecise so that the dimension of the connecting piece is hard to be controlled with wasted material. Since melting at high temperature alters the internal structure of the material, stability of the final product is impaired.

3. For forging imitation, the hollow piece or the two thick plate is/are welded to two lateral sides of a rear extension of a blade, ensures a large contact surface. A welded connection, however, is established only at a circumference thereof rather than in a central contact area. Due to the outer surface thereof being required to conduct grinding treatment, it results in an insufficient joining area for welding. Hence, it is helpless for the strength of the knife itself and it causes cumbersome working with inaccuracy.

4. The preceding three ways of working are belonged to forging imitation so that simplified production of knives can be attained, but fail to achieve quality and strength of a knife made by way of the real forging work.

### SUMMARY OF THE INVENTION

The present invention provides a blade and a connecting piece for a knife, which are separately forged and then connected by welding. Thus, working is simplified as compared to manufacturing in a single step. Where the blade and the connecting piece are connected, a groove is formed, so that the blade is inserted in the connecting piece, resulting in an enlarged contact surface, thus avoiding the shortcoming of a conventional blunt contact surface with little strength. The present invention allows not only to be used in conjunction with forged knives, but also with any kind of knife having a connecting piece.

It is the main object of the present invention to provide a knife blade assembly, which can be fabricated in high quantity due to reduced working effort and cost with maintaining the original feature of a forged knife blade assembly.

Another object of the present invention is to provide a knife blade assembly, which is suitable for any design of knives having connecting pieces with increased strength, simplified manufacturing process and lowered production cost.

### BRIEF DESCRIPTION OF THE DRAWINGS

The present invention can be more fully understood by reference to the following description and accompanying drawings, in which:

FIG. 1 is a schematic illustration of the knife blade assembly of the present invention;

FIG. 2 is a schematic illustration of the knife blade assembly of the present invention in another embodiment;

FIG. 3 is a schematic illustration of the present invention in conjunction with a handle; and

FIG. 4 is a schematic illustration of the present invention in conjunction with a handle in another embodiment.

### DETAILED DESCRIPTION OF THE PREFERRED EMBODIMENTS

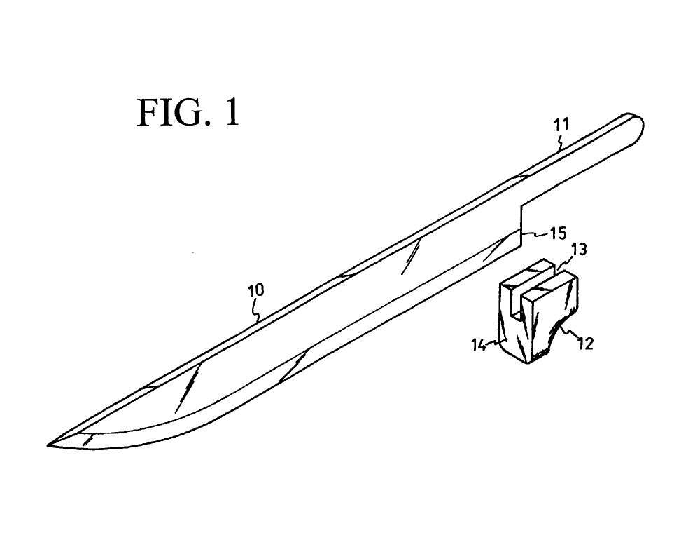

As shown in FIG. 1, the knife blade assembly of the present invention in a first embodiment mainly comprises a blade 10 and a connecting piece 12. The connecting piece 12 on an upper side thereof has a groove 13, into which a rear extension 11 of the blade 10 is inserted. The groove 13 and the rear extension 11 are welded together to form a single body. The blade 10 has a rear end with a rear side 15. The rear side 15 and the connecting piece 12 contact each other at a contact surface 14 and are blunt-welded together there. By inserting the rear extension 11 into the connecting piece 12, a firm connection is established as compared to conventional connections.

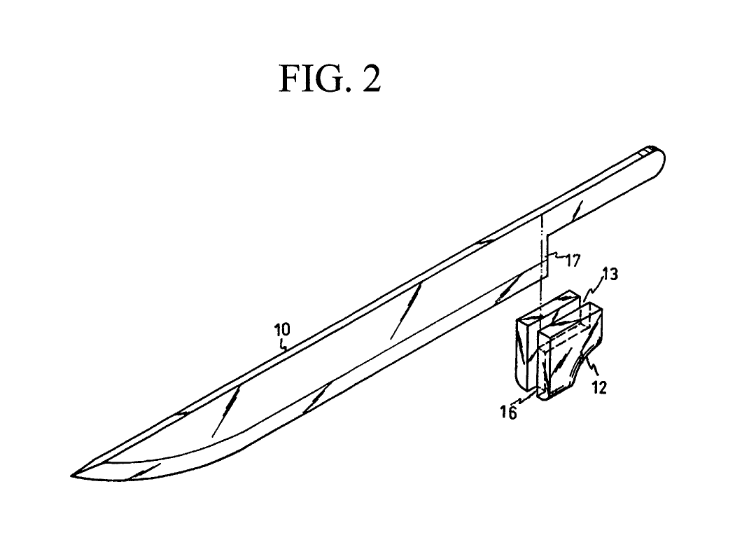

As shown in FIG. 2, the present invention in a second embodiment has a second groove 16 on a front side of the connecting piece 12. While the rear extension 11 is inserted into the groove 13, the second groove 16 takes in a rear part 17 of the blade 10. Thus a widely overlapping contact surface between the blade 10 and the connecting piece 12 is formed. During use, the rear part 17 is firmly held in the second groove 16 of the connecting piece 10, and high forces are applicable.

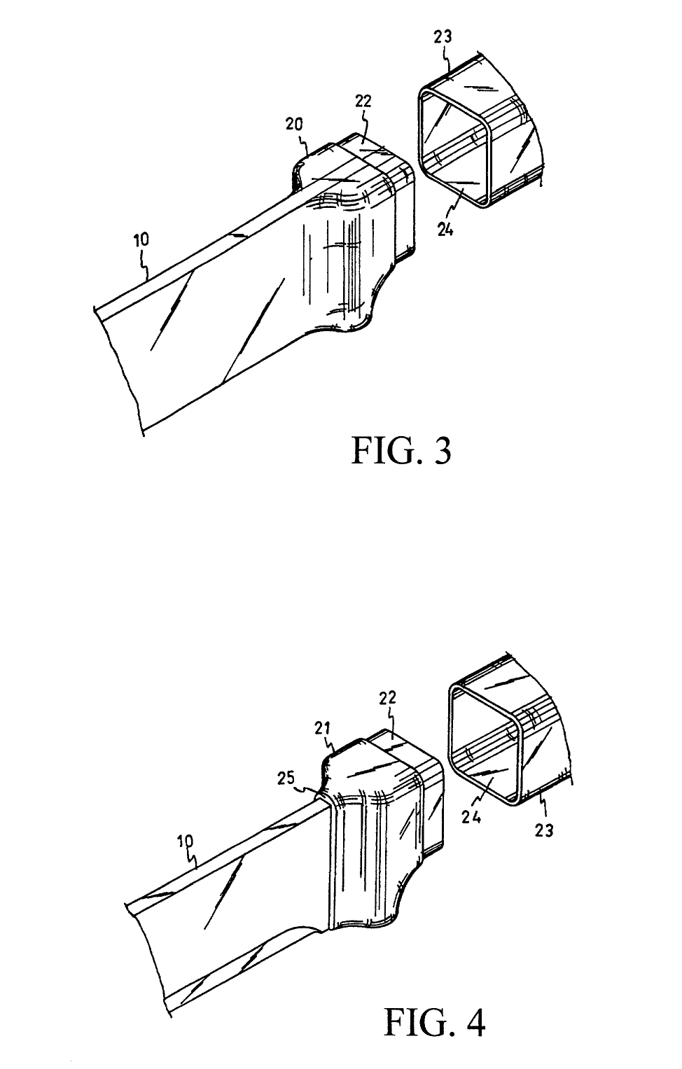

Referring to FIG. 3, with the blade 10 and the connecting piece 12 being welded together, the rear end of the connecting piece 12 has an insertion part 22. The insertion part 22 is inserted into an opening 24 of a handle 23 so that the connecting piece 12 and the handle 23 overlap to ensure a firm connection. Alternatively, an integral body is formed by welding, if the handle is made of metal, or by gluing or riveting, if the handle is not made of metal.

Referring to FIG. 4, with the blade 10 and a connecting piece 21 being welded together, for further increased strength, the rear extension 11 is completely enclosed and welded so that the connecting piece 21 forms a back ridge of the knife. The rear end of the connecting piece 21 has an insertion part 22. The insertion part 22 is inserted into an opening 24 of a handle 23 so that the connecting piece 12 and the handle 23 overlap each other for ensuring a firm connection. Alternatively, an integral body is formed by way of welding, if the handle is made of metal, or by way of gluing or riveting, if the handle is not made of metal.

While the invention has been described with reference to preferred embodiments thereof, it is to be understood that modifications or variations may be easily made without departing from the spirit of this invention which is defined by the appended claims.

What is claimed is:

1. A knife blade assembly, comprising
a blade with a rear extension;
a connecting piece, providing a first insertion part at an upper side thereof, and the rear extension of said blade being inserted therein and firmly connected therewith; and
a handle, being joined to the rear extension.

2. A knife blade assembly according to claim 1, wherein the first insertion part in said connecting piece at a front end thereof has a second insertion part being inserted with a rear part of said blade firmly.

3. A knife blade assembly according to claim 1, wherein said connecting piece encloses said rear extension, forming a knife back.

4. A knife blade assembly according to claim 1, wherein a further insertion part is disposed at a rear end of said connecting piece for being inserted in the handle.

5. A knife blade assembly according to claim 2, wherein a further insertion part is disposed at a rear end of said connecting piece for being inserted in the handle.

6. A knife blade assembly according to claim 3, wherein a further insertion part is disposed at a rear end of said connecting piece for being inserted in the handle.
